(19) United States
(12) Patent Application Publication
(10) Pub. No.: US 2017/0120087 A1
(43) Pub. Date: May 4, 2017

(54) PROTECTIVE EQUIPMENT

(71) Applicant: TREEMAGINEERS LTD., Pitlochry (GB)

(72) Inventors: Christopher Sidney COWELL, Pitlochry (GB); Elliot James TANNER, Gwynedd (GB)

(21) Appl. No.: 15/336,927

(22) Filed: Oct. 28, 2016

(30) Foreign Application Priority Data
Oct. 30, 2015 (GB) 1519266.9

(51) Int. Cl. A62B 35/00

(52) U.S. Cl. CPC A62B 35/0006

(57) ABSTRACT

Harnesses are disclosed that comprise a back, a flexible load-bearing member and a side connection arrangement, in which each side connection arrangement includes a base that is fixed to the back and a primary connection element removably connected to the base, in which the flexible load-bearing member is connected to the connection element such that upon removal of the connection element from the base, the load-bearing member can be removed from or connected to the connection element.

### BACKGROUND TO THE INVENTION

Field of the Invention

This invention relates to personal protective equipment and, more particularly, harnesses or components thereof. Particularly, but not exclusively, the invention relates to components used to make a harness suitable for use in supporting a person working at height using rope access and hardware (metal components) that are used within its construction. It also has application for a harness and hardware that are part of a fall-protection system.

A harness may be designed to support a user when working at height, to provide a comfortable body support for performing tasks when suspended from a rope access system. Alternatively or additionally, a harness may be used to arrest a user's fall, for example in a fall protection system used by a climber where there is the potential for a fall. Embodiments of the invention might find application to hardware used for rope access, industrial height safety, rescue, tactical applications, sport climbing, etc. Within this specification, example embodiments will be described that relate to harnesses intended for use in tree care, but this should not be taken to be limiting upon the range of applications of the invention.

Summary of the Prior Art

This application relates to the components of a harness assembly which is of the general construction shown in FIGS. 1 to 3.

A known harness is shown in FIG. 1A. The harness comprises two leg loops 10 that, in use, encircle a user's thighs. Each leg loop 10 is connected to a padded back 12 that rests against the small of a user's back and has side wings that extend to above a user's hips when in use. The back has a waist webbing 14 that has ends that can be interconnected by a releasable front waist buckle 16.

Each side wing has a side attachment arrangement 20, shown in more detail in FIG. 1B. Each side attachment arrangement 20 connects the waist webbing 14 in the region of the wing through a riser webbing 18 to the corresponding leg loop 10. In this known arrangement, the side attachment arrangement 20 comprises two metal loops 22, 24 through which the waist webbing 14 passes.

Existing products and designs typically use a multitude of components to create a side attachment assembly. Not only does this produce a side attachment arrangement that is difficult to build into a harness at the manufacturing stage, it also gives limited opportunity following manufacture to replace textile elements, which are susceptible to wear through abrasion or other damage such as cuts, heat damage, and so forth. This can lead to users making their own solutions for repairing a worn side attachment assembly, which is undesirable because the effectiveness of such a repair cannot be guaranteed, or the harness being retired from service while many of its components are still well within their working lives.

Existing harnesses use a pair of symmetric forward attachment arrangements 26 as shown in FIG. 1 to suspend a flexible load bearing member 28 across the front of the harness. For use, the flexible load-bearing member 28 carries a sliding attachment device which attaches to a climbing line. Typical known forward attachment arrangements include a connector 27 shown in FIG. 2 that is sewn in to the riser 18 and leg loop 10 webbing. The flexible load-bearing member 28 is tied in to the connector 27 during manufacture of the harness. The flexible load bearing member 28 can be adjusted in length by repositioning a knot on the one end by the user which is time consuming and potentially hazardous for the user if done incorrectly.

### SUMMARY OF THE INVENTION

An aim of this invention is to provide a harness that that overcomes or at least ameliorates these disadvantages.

This invention provides an attachment assembly for a harness that includes a body for connection to a back of a harness and a ring or other formation pivotally and removably connected to the body and to a webbing that is part of the harness.

From a second aspect, this invention provides a harness comprising a back, a flexible load-bearing member and a side connection arrangement, in which each side connection arrangement includes a base that is fixed to the back and a primary connection element removably connected to the base, in which the flexible load-bearing member is connected to the connection element such that upon removal of the connection element from the base, the load-bearing member can be removed from or connected to the connection element.

This allows the riser element to be disconnected from the side connection arrangement and replaced without a user having to perform an operation such as cutting, knotting or sewing the riser. Thus, the riser can be repeatedly renewed when it becomes worn in a controlled, efficient and safe manner, by a person with limited resources or technical ability.

In a typical embodiment, the connection element is in the form of a shackle. Such as shackle may comprise a C-shaped loop of metal. The connection element may be connected to the base by a removable bolt. The connection element may be free to pivot (e.g., about the bolt) while connected to the base.

The side connection arrangement may further include a secondary connection element. This can be used as an attachment point to which a connection can be made and released during use of the harness. The secondary connection element may be in the form of a shackle. The primary and secondary connection elements me be configured to pivot with respect to the base about a common axis. Alternatively, the primary and secondary connection elements me be arranged such that each can pivot with respect to the base about a respective axis, for example the axes being angled with respect to each other.

The base is formed from two interconnected components that can pivot with respect to one another. This can increase its ability to conform to the shape of the body of a user.

In a typical configuration, a harness embodying the invention may have two, typically similar, side connection arrangements, the load-bearing member extending between the primary connection elements of the side connection arrangements. A harness typically has leg loops, the flexible load-bearing member being a riser extending from each leg loop to be secured to the primary connection element of a respective side connection arrangement.

Typically, a harness includes a buckle for releasably interconnecting two free ends of the waist webbing. Moreover, a harness typically includes a waist webbing adjuster operable to adjust the length of the waist webbing when the harness is in use.

A harness embodying the invention may include a waist webbing connected to each of the side connection arrangements. A buckle may be included for releasably interconnecting free ends of the waist webbings. A waist webbing adjuster operable to adjust the length of the waist webbing when the harness is in use is preferably included.

### BRIEF DESCRIPTION OF THE DRAWINGS

FIGS. 1A and 1B show an existing harness, and have already been discussed;

FIG. 2 shows a connector of a forward attachment arrangement of an existing harness, and has already been discussed;

FIGS. 3 to 10 show a side attachment arrangement of a harness embodying the invention;

FIG. 11 shows a side part of a harness embodying the invention;

FIG. 12 shows an alternative arrangement for connection of a side attachment arrangement embodying the invention to a harness;

FIGS. 13 to 15 show a side attachment arrangement of a harness being a second embodiment of the invention;

FIGS. 16 to 20 show a third embodiment of the invention;

FIGS. 21 to 24 show a third embodiment of the invention; and

FIGS. 25 to 27 show a fourth embodiment of the invention;

FIG. 28 is an exploded view of a base of the embodiment of FIGS. 25 to 27;

FIG. 29 shows the fourth embodiment of the invention in use on a harness;

FIG. 30 shows an embodiment that is a modification to the fourth embodiment;

FIG. 31 shows the embodiment of FIG. 30 in use on a harness;

FIGS. 32 to 36 shows a forward attachment arrangement being an embodiment of the invention; and

FIGS. 37 to 41 show diagrammatically the forces acting on the arrangement of FIGS. 32 to 36.

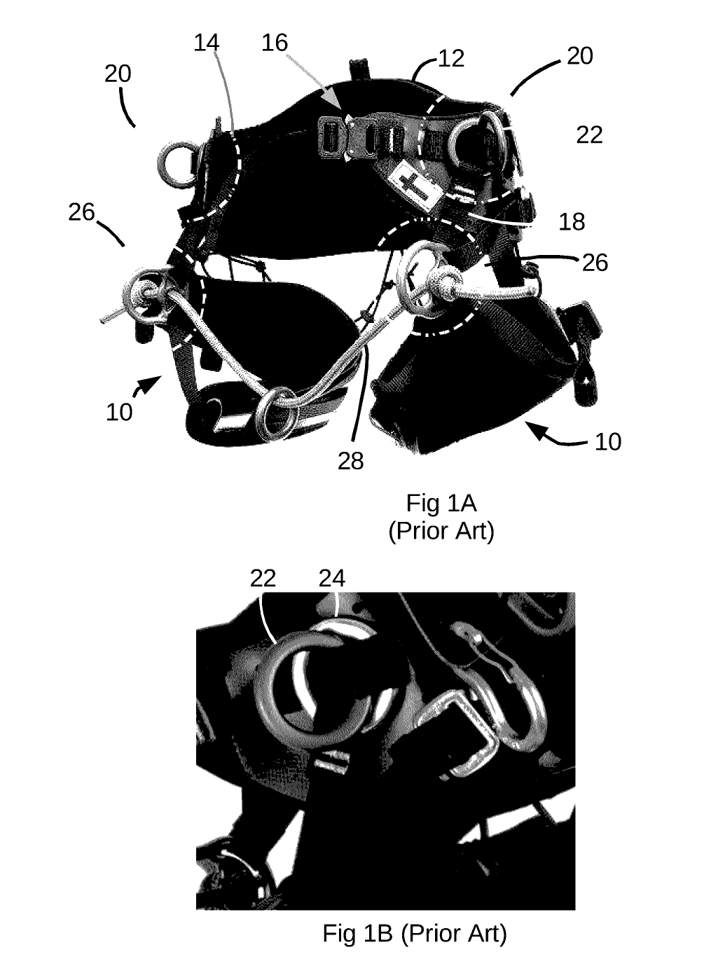

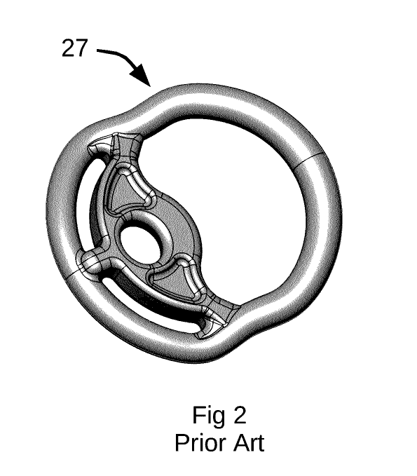

### DETAILED DESCRIPTION OF THE PREFERRED EMBODIMENTS

Embodiments of the invention will now be described in detail, by way of example, with reference to the accompanying drawings.

In the following description, the features described are to be considered as optional features of embodiments of the invention and features described with reference to one embodiment may be incorporated into another.

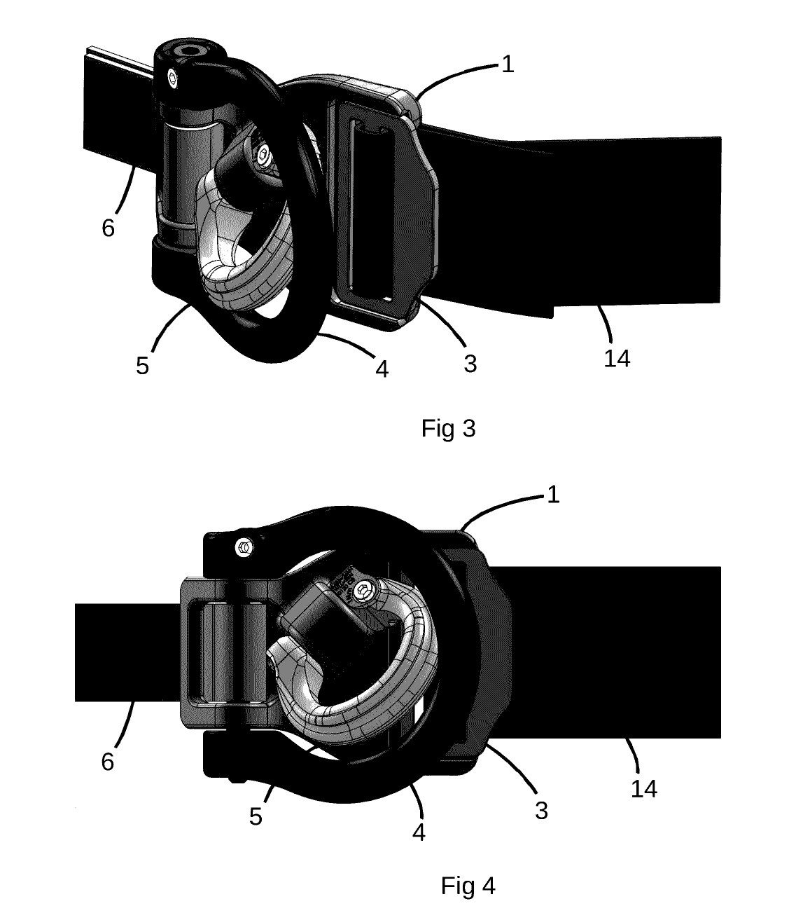

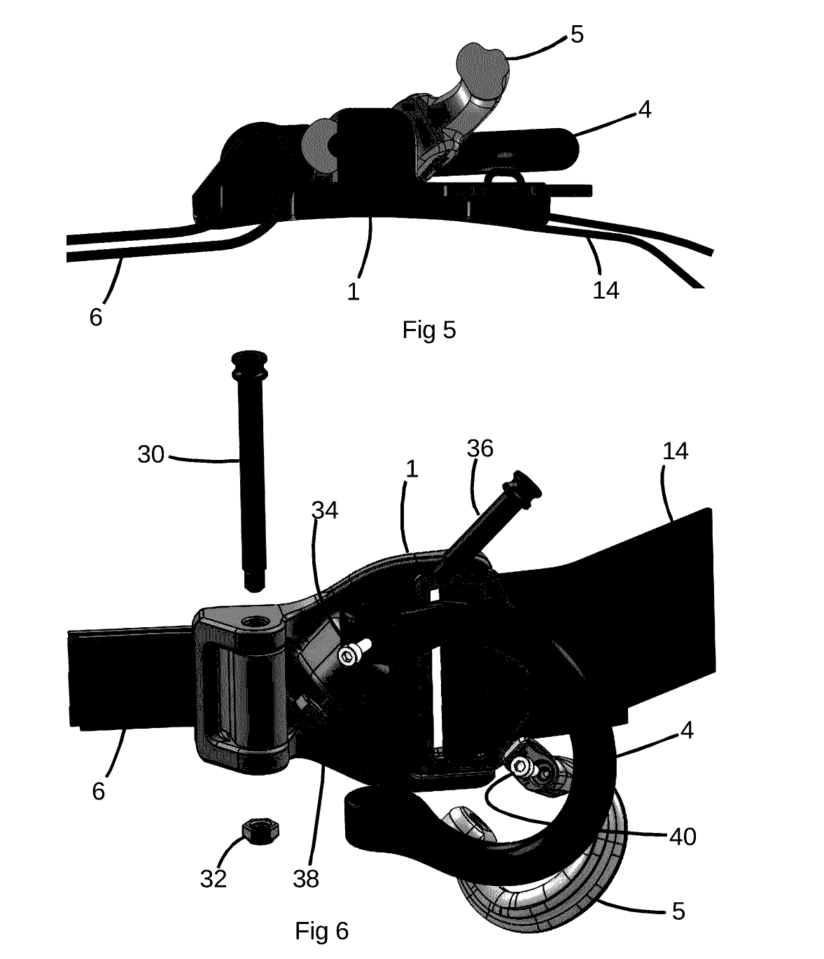

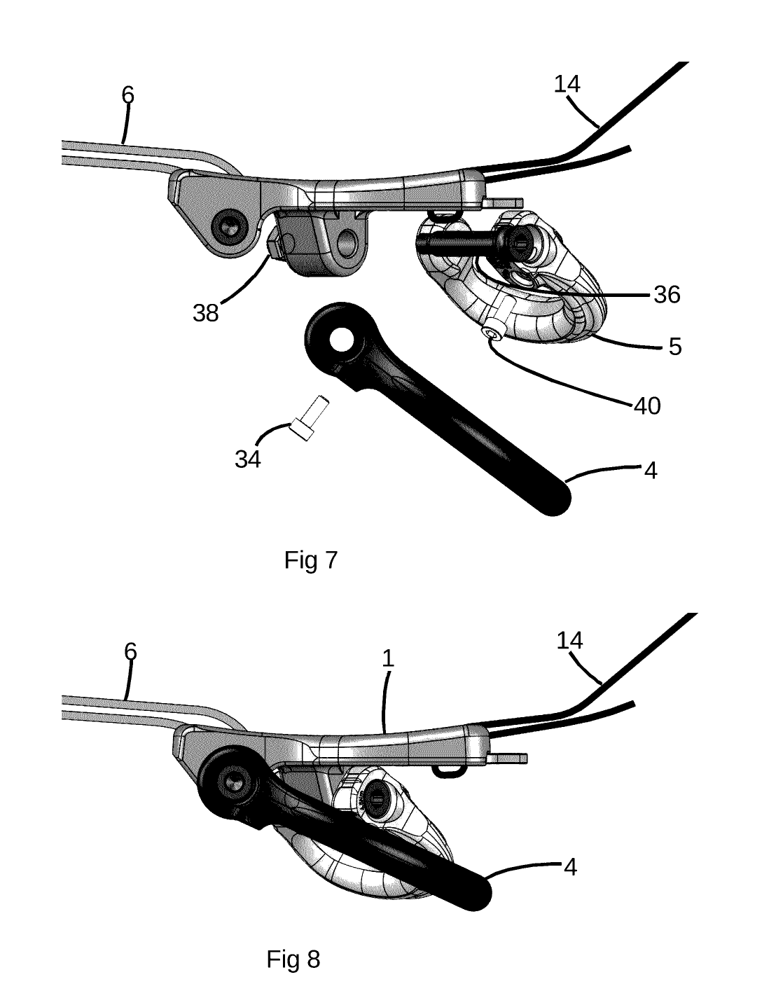

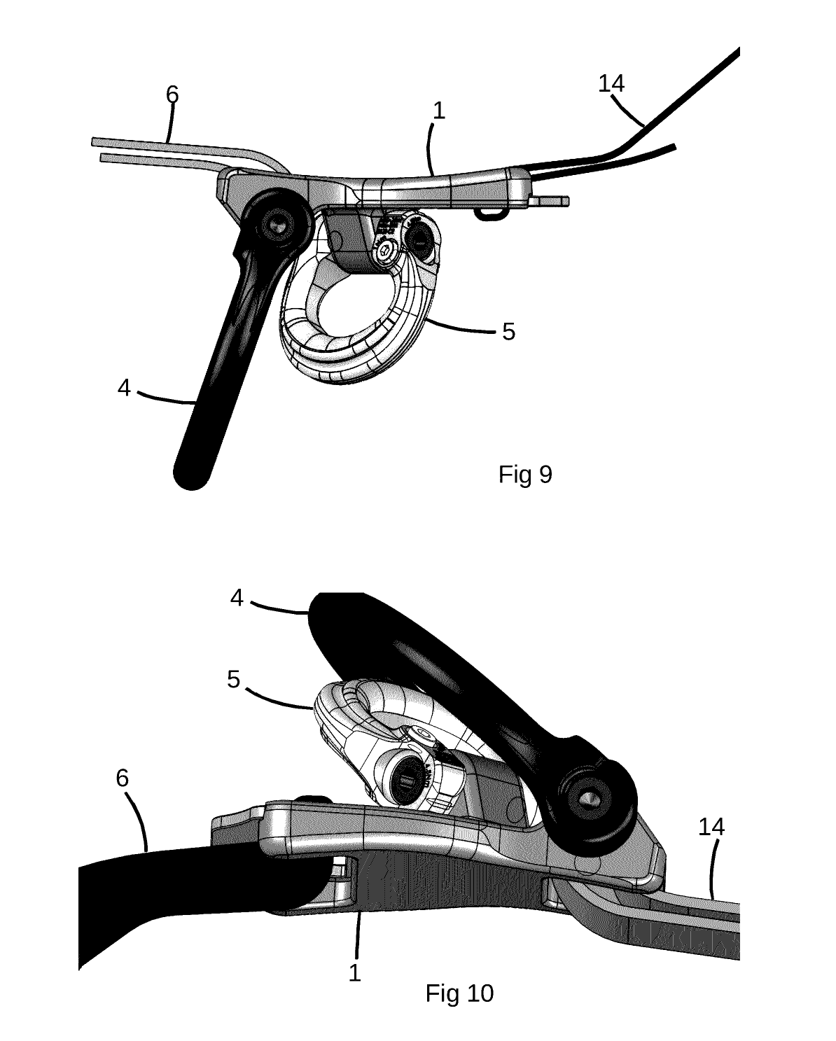

The terminology used in this application will now be set forth, with reference to FIG. 3:

Body 1: The main portion of the assembly that links all other parts together;

Harness waist webbing 14: Webbing that runs around the waist of the harness to join the two side attachment arrangements through a front waist buckle;

Buckle plate 3: For adjusting the length of the waist webbing 14 to fit different sizes of user;

Side attachment loop 4: For attaching to anchors or for supporting objects such as tools.

Riser webbing shackle 5: Riser webbing 18 is connected to the riser webbing shackle for example by sewing.

Back pad webbing 6: extends across the back of the harness to interconnect the two side attachment arrangements 20.

The side attachment loop 4 is approximately C-shaped. It is connected to the body 1 by a first pivot pin 30 that passes through holes in end portions of the side attachment loop 4 and bores in the body 1. The first pivot pin 30 is retained by a nut 32 and a pinch bolt 34 secured within the side attachment loop 4. A loop is formed in an end portion of the back pad webbing 6, the pivot pin 30 passing through the loop to retain it connected to the body 1.

The riser webbing shackle 5 is approximately C-shaped and is smaller than the side attachment loop 4. It is connected to the body 1 by a second pivot pin 36 that passes through holes in end portions of the riser webbing shackle 5 and bores in the body 1, the second pivot pin 36 extending at an angle of approximately 30° to the first pivot pin 30. The second pivot pin 36 is retained by a nut 38 and a pinch bolt 40 secured within the riser webbing shackle 5. A loop is formed in an end portion of the riser webbing 18, the riser webbing shackle 5 passing through the loop to retain it connected to the body 1.

Pivoting attachment points (riser webbing shackle and side attachment point) reduce stress in system and reduce wear as parts can adapt to the angle of loading. Compared with known devices, this can mean:
Increased compactness and reduced size of the connection assembly.
Ergonomic shape to body.
Built in adjustability in one unit.
Riser webbing shackle for attaching the riser webbing to the body of the side attachment arrangement. This attaches using a removable locking pin to allow replacement of the webbing.
Waist Webbing. This webbing may attache around the same axle that secures the side attachment arrangement to the body. The webbing runs around the back of the harness.

The riser webbing shackle and the side attachment point are pivotal with respect to the body to reduce force on the Body by manipulating to the angle of the webbing/orientation of the user.

As can be seen from the drawings, the body 1 has a curved profile that fits to a user's body shape better than the conventional combination of hardware rings.

The body can be reduced in size to be smaller than a current side D setup but have more functionality i.e., it combines a D-Ring, a riser webbing attachment and buckle adjuster.

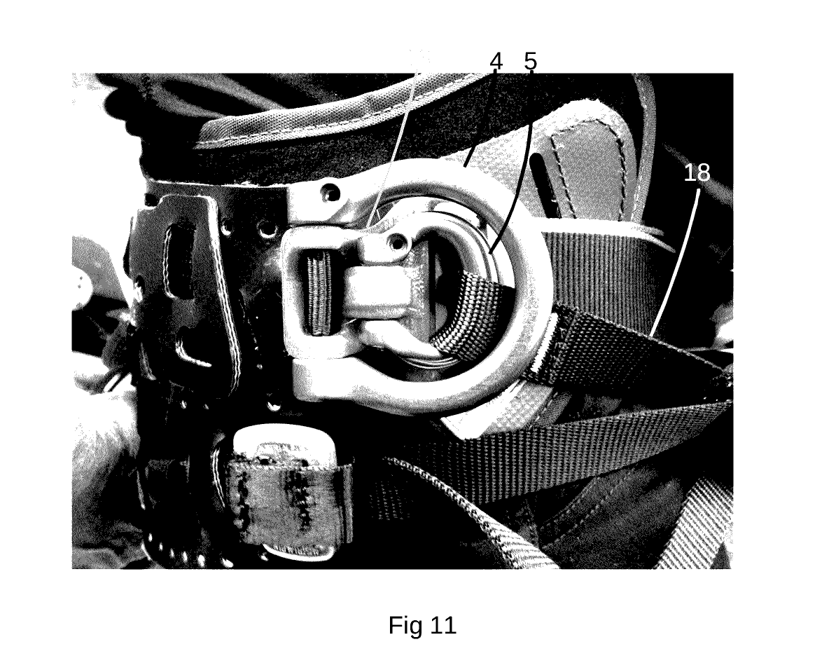

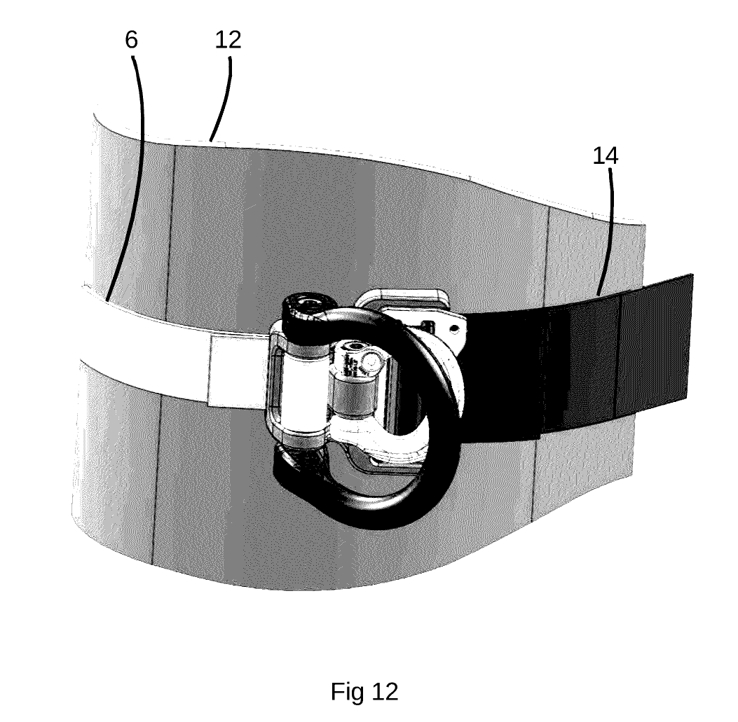

The side attachment arrangement 20 can be secured through sewing, bolting or otherwise fixing the body to the padding 12 as shown in FIGS. 11 and 12. This holds the side attachment arrangement 20 in place relative to the rest of the harness. The securing features may allow the side attachment arrangement 20 to be positioned in more than one location on the padding 12.

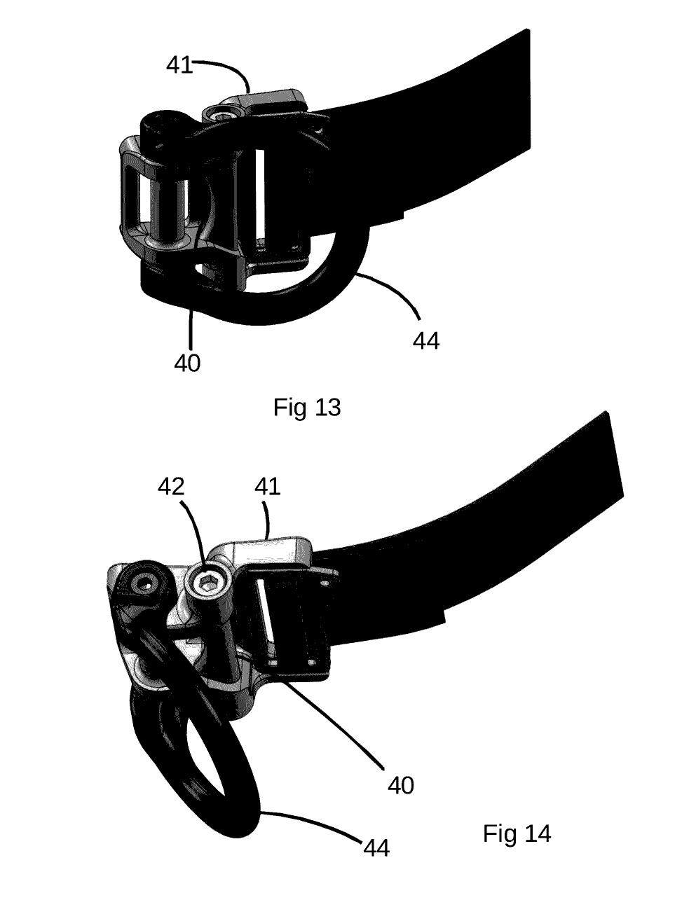

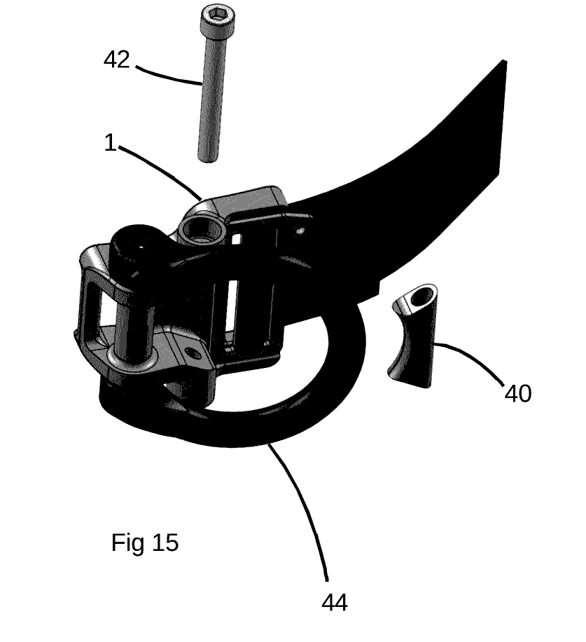

As shown in FIGS. 13 to 15, in some applications, the riser webbing shackle is superfluous to requirements, and may therefore be omitted from embodiments of the invention. As full outward articulation of the first embodiment is potentially not required, in this variation the shackle has been replaced by a shaped spacer 40 with a removable pin 42 allows some articulation with respect to the body 41 but is simplified in its construction compared to the shackle shown in other variations. This spacer allows webbing passing over it to adapt to angles of roughly 70°.

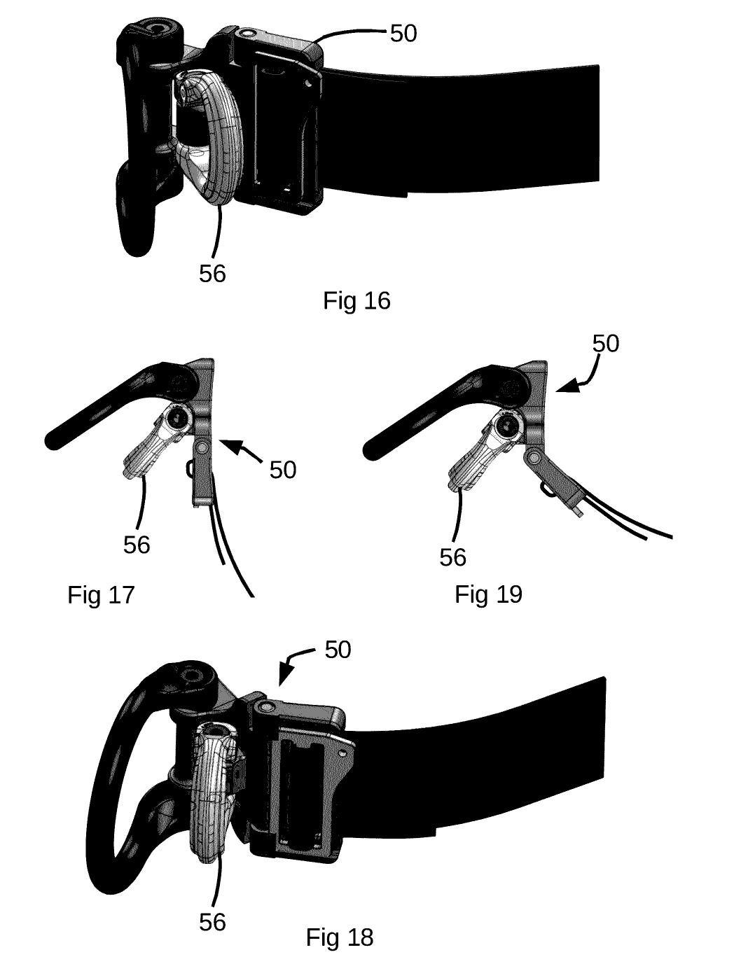

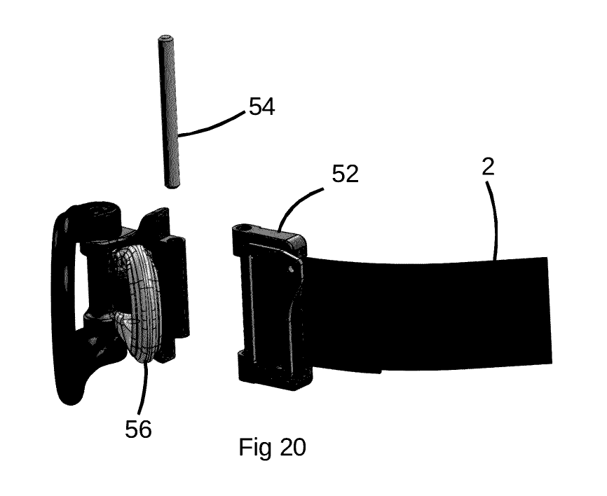

With reference to FIGS. 16 to 20, in further embodiments, the body 50 can articulate about a pin 54 to ensure an even better fit to the user's profile. This articulation would take place between the buckle 52 and attachment 56 for the riser webbing shackle.

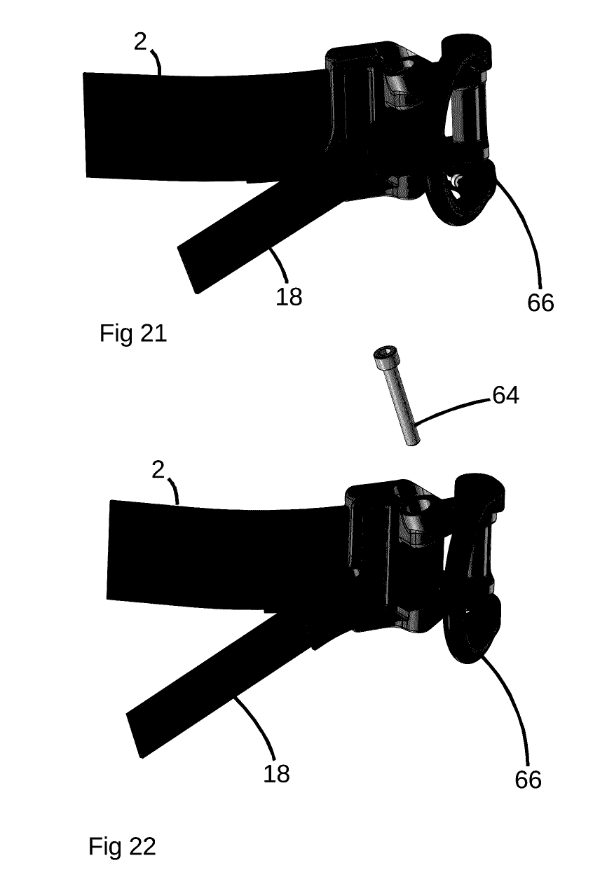

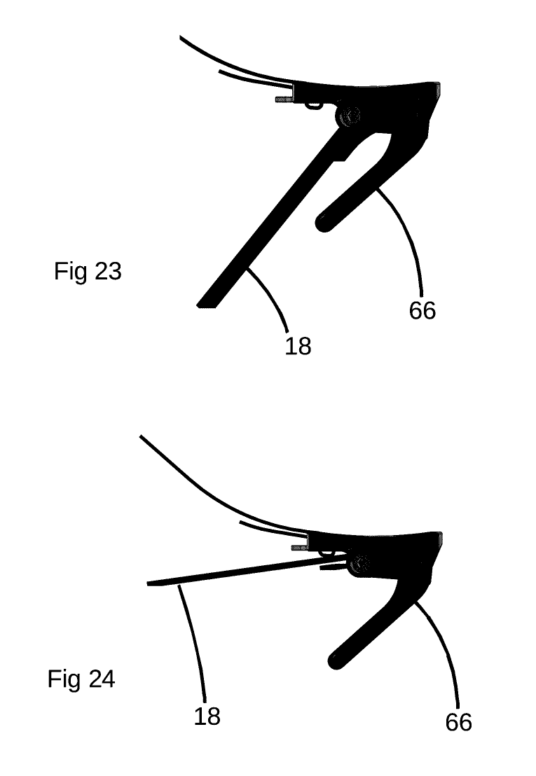

A simplified embodiment is shown in FIGS. 21 to 24 has a fixed riser webbing attachment 66 at an angle. This would not articulate but would be angled at roughly 20° to deal with most riser webbing orientations. This design still allows outward/inward articulations through a removable pin 64.

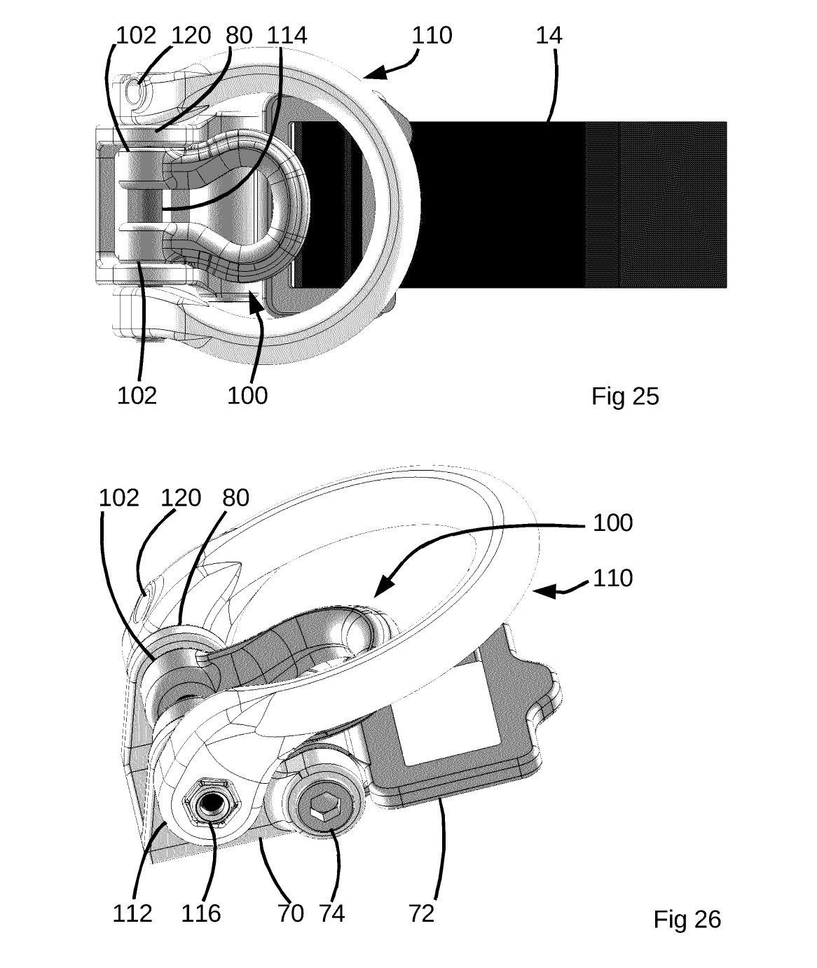

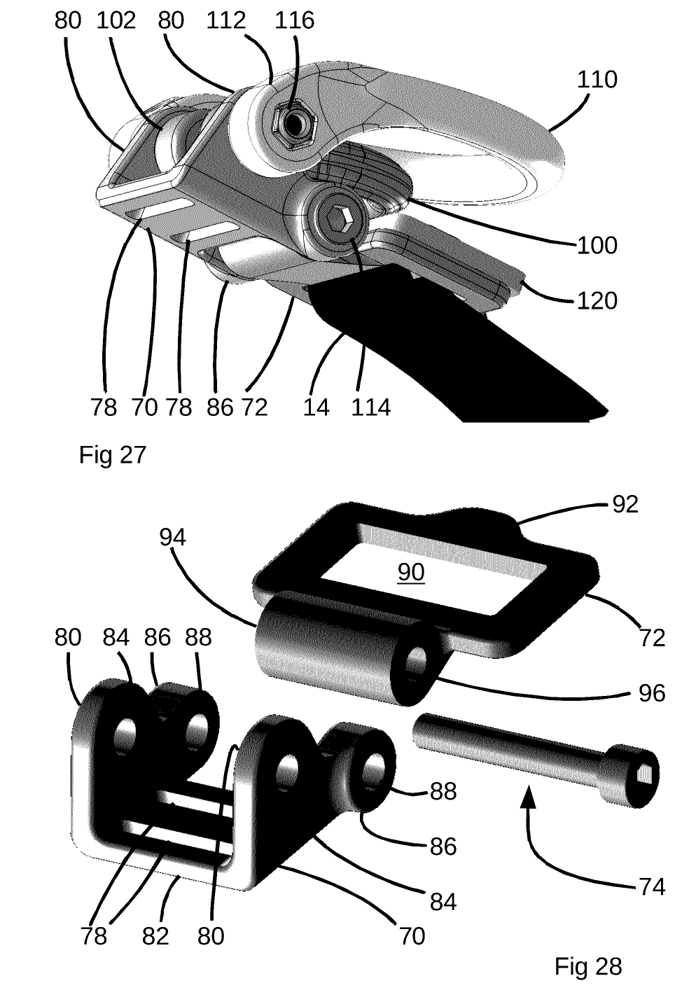

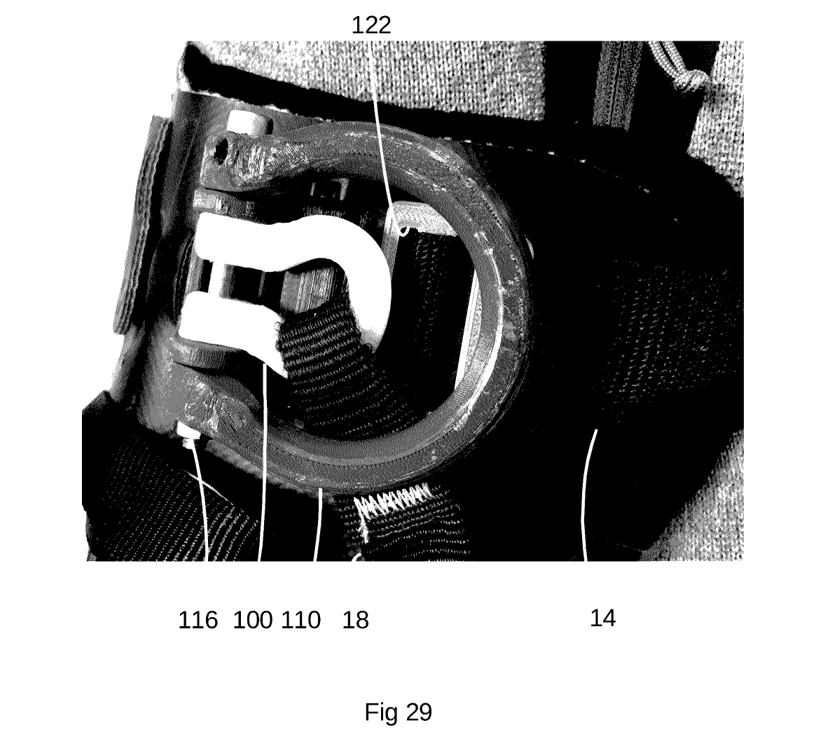

A further side attachment arrangement is shown in FIGS. 25 to 28.

This embodiment includes a base that comprises two components: a shackle block 70 and a buckle block 72 interconnected by a cap-headed bolt 74. The shackle block 70 has a generally U-shaped profile having two lugs 80 projecting perpendicularly from a base 82. A through-hole 84 is formed in each lug 80, the through-holes 84 being in alignment with one another. The shackle block 70 further includes two bosses 86 that extend from opposite sides of the base 82 adjacent to the lugs 80. A through-hole 88 is formed in each boss 86, the through-holes 88 being in alignment with one another, one through-hole 88 being counterbored with a cylindrical recess and the other being counterbored with a hexagonal recess. Parallel slots 78 are formed through the base 82.

The buckle block 72 is a plate of generally rectangular outline with a rectangular hole 90 formed through it. A tab 92 projects centrally from one long side of the buckle block 72. A tubular extension 94 is carried on an opposite long side, the tubular extension 94 having a through bore 96 that extends parallel to the long sides. The through bore 96 opens to parallel end surfaces of the tubular extension 94 that are spaced apart by a distance slightly less that the spacing between the bosses 86.

To assemble the base, the tubular extension 94 of the buckle block 72 is placed between the bosses 86 with its bore 96 in alignment with the through-holes 88 of the bosses 86. A self-locking nut is placed into the hexagonal counterbore and the bolt 74 is then inserted through the through-hole 88 that has a cylindrical counterbore, and the bore 96 and then it is threaded into the nut. This securely connects the buckle block 72 to the shackle block 70 and allows relative pivotal movement between them to take place about the bolt 74. The buckle block 72 could alternatively be connected to the shackle block by riveting.

The side attachment arrangement further includes an inner shackle 100 carried on the base to form a primary connection element of the side attachment arrangement. The inner shackle 100 is a generally C-shaped loop of metal that is of generally rounded section other that at opposite end regions 102, which are rectangular in section. A through-hole extends through each end region, the through-holes being in alignment with one another. Flat, parallel outer surfaces of the end regions, through which the through-holes emerge, are spaced apart by a distance just less than the distance between the lugs 80 of the shackle block 70.

The side attachment arrangement further includes an outer shackle 110 carried on the base to form a secondary connection element of the side attachment arrangement. The outer shackle 110 is a generally C-shaped loop of metal that is of rounded section other that at opposite end regions 112, which are rectangular in section. A through-hole extends through each end region, the bores being in alignment with one another. one through-hole being counterbored with a cylindrical recess and the other being counterbored with a hexagonal recess. Flat, parallel inner surfaces of the end regions, through which the through-holes emerge, are spaced apart by a distance just less than the distance between outer surfaces of lugs 80 of the base.

To assemble the side attachment arrangement the inner shackle 100 is threaded through a loop sewn at the end of the riser webbing 18 and/or a flexible load-bearing member, and placed between the lugs 80. A hexagonal self-locking nut 116 is placed into the hexagonal counterbore of the end region 112 of the outer shackle 110. A cap-headed screw 114 is inserted into the cylindrical recess, through the corresponding through-hole of the outer shackle 110, then through the hole 84 in a first one of the lugs 80, through the through-holes in the end regions 102 of the inner shackle 100, the second lug 80, the outer shackle 110 to engage with the nut 116 in the hexagonal counterbore. The screw 114 can be locked by a pinch bolt inserted into a threaded bore 120 that intersects the cylindrical counterbore. The inner shackle 100 and the outer shackle 110 can pivot on the cap screw 114 with respect to the shackle block 70. The presence of the screw 114 prevents removal of the loop of the riser webbing 18 from the inner shackle 110. However, when replacement of the riser webbing 14 becomes necessary, the screw 114 and the inner shackle can be removed to allow the riser webbing 18 to be replaced.

To attach the side connection arrangement to the harness, an end portion of the back pad webbing 6 is threaded through the slots 78 in the base 82 and sewn to form a complete loop to permanently attach the connection arrangement.

The outer shackle 110 is intended to provide an anchorage point to which a connector such as a carabiner 132, can be attached and removed while the harness is in use.

A buckle plate 120 is formed from a rectangle of metal of substantially the same size as the buckle block 72. Two spaced parallel slots 122 are formed through the buckle plate 120, extending parallel to its long edges with a length approximately that of the width of the waist webbing 14.

To connect the side attachment arrangement to the waist webbing 14, an end of the webbing 14 is passed through the hole 90 in the buckle block 72 towards the shackles 100, 110. It then passes through each of the slots in the buckle plate 120 in turn, and returns back through the hole 90. This allows the position of the wait webbing to be adjusted with respect to the side attachment arrangement.

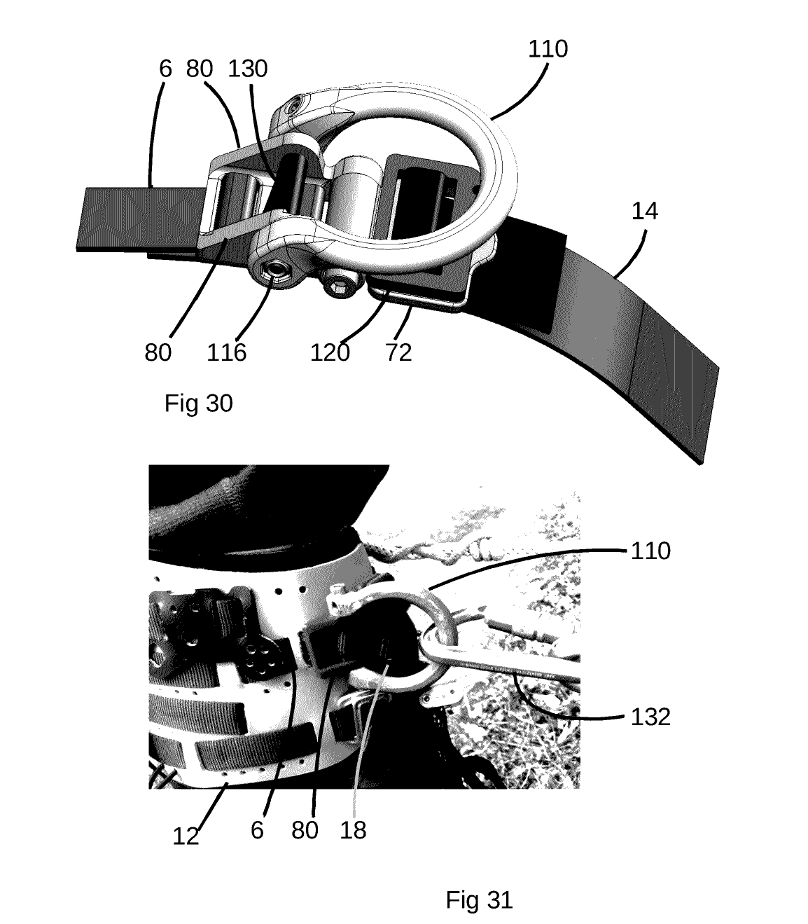

A modification of this embodiment is shown in FIGS. 30 and 31. In this embodiment, the inner shackle is omitted and a tubular spacer 130 is inserted in its place to constitute the primary connection element. The spacer 130 is inserted through a loop at the end of the riser webbing 18 prior to being connected to the base by the screw 114, which extends through a bore within the spacer. An outer surface of the spacer 130 has is shaped such that the cross-sectional shape of the spacer is trapezoidal, to accommodate the angle at which the riser webbing extends from it. Note that the spacer could be omitted, with the loop at the end of the riser webbing being supported directly upon the screw 114.

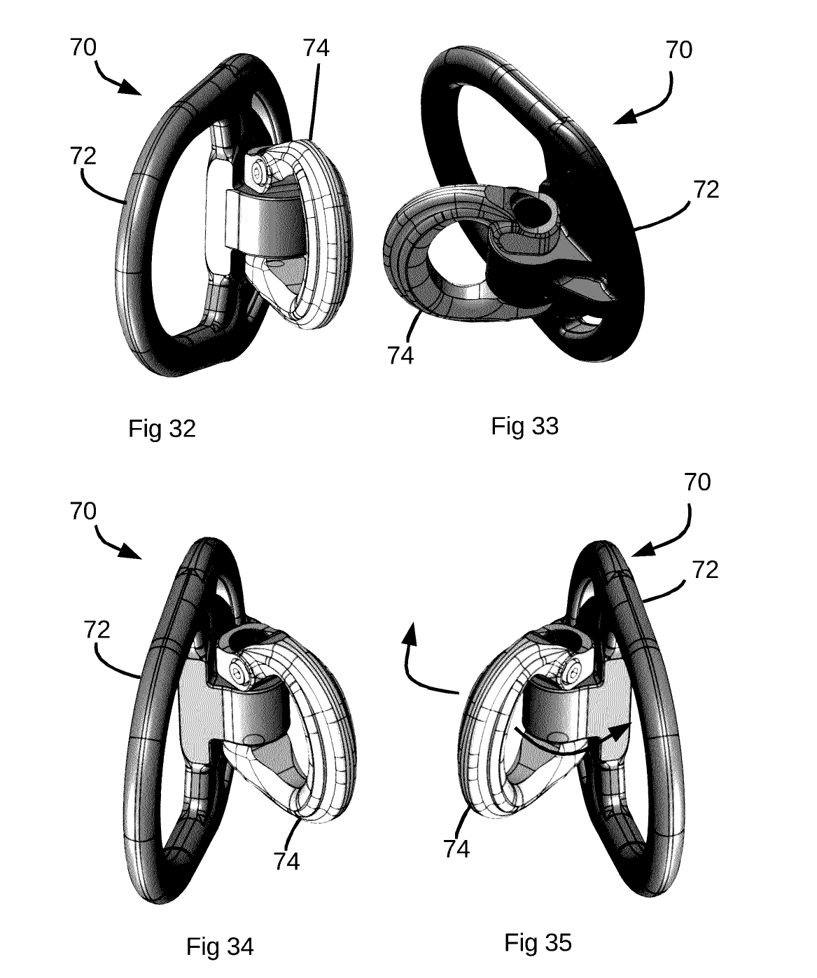

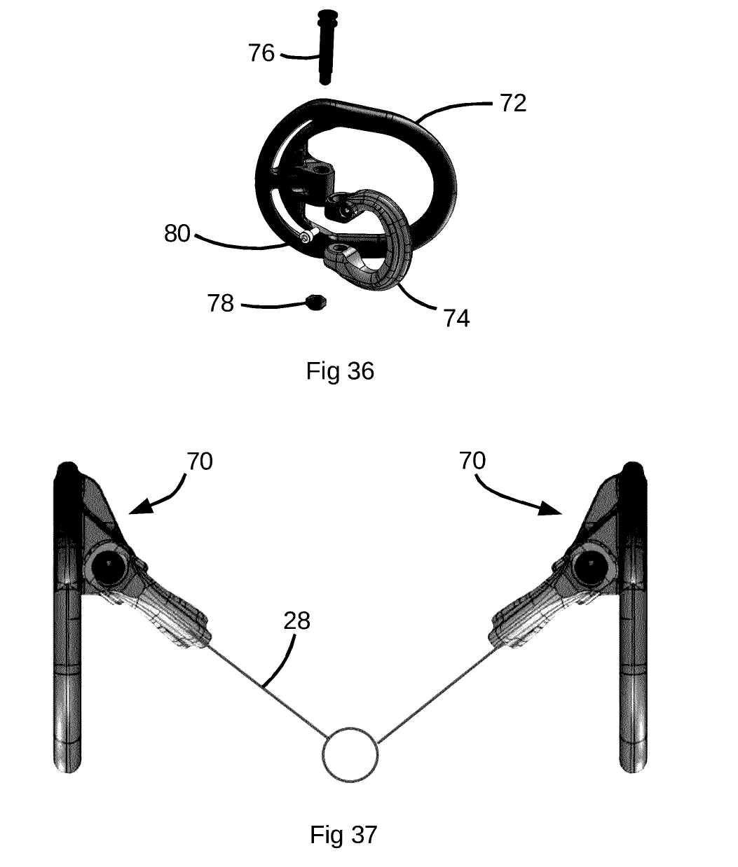

With reference to FIGS. 32 to 36, a forward attachment arrangement 26 includes a connection element 70 that is a variation on the existing Forward D design that has a shackle attachment boss instead of a rope hole and is generally flat in profile. The forward connection element 70 comprises a body 72 with a shackle attachment. A C-shaped pivoting shackle 74 with smooth surface for the flexible load bearing member is connected to the body 72. The body 72 and the shackle 74 are interconnected by a removable axle 76. The axle is secured by a removable nut 78 and bolt 80. This design is similar to the existing forward D′s in that it can be attached to by tying a textile element in to a rope hole and the D-ring is clippable with a carabiner.

The body 72 has a shackle attachment which is removable by the user. The shackle is locked in to place using a specially constructed axle, locking nut and secondary cross locking bolt to ensure a high level of user intuitive security.

The shackle74 can articulate about the removable axle 76 with respect to the body 72 to adapt to the various positions the user could move to, adopting configurations as shown in FIGS. 30 to 33.

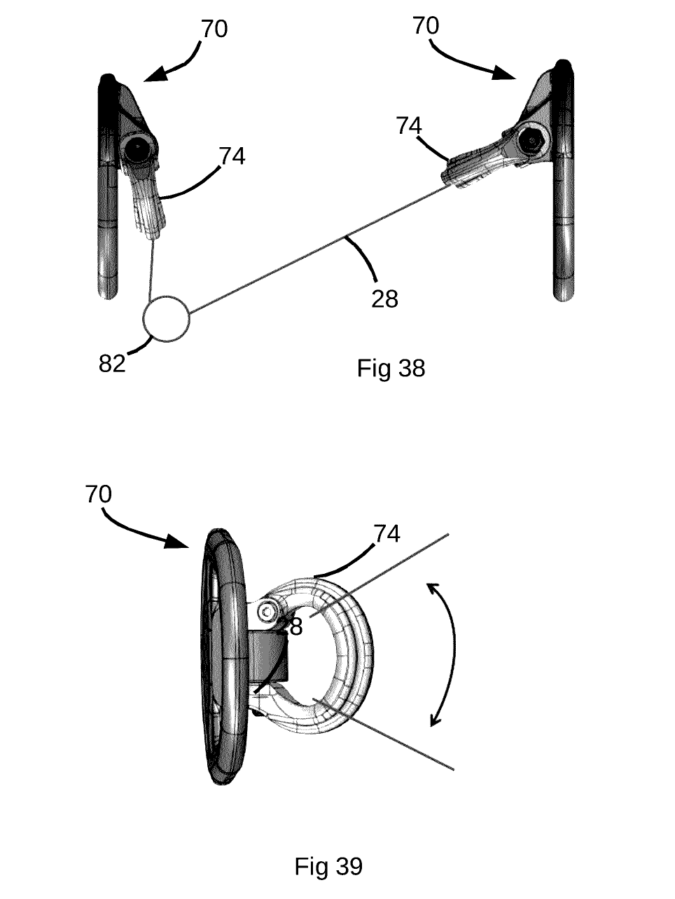

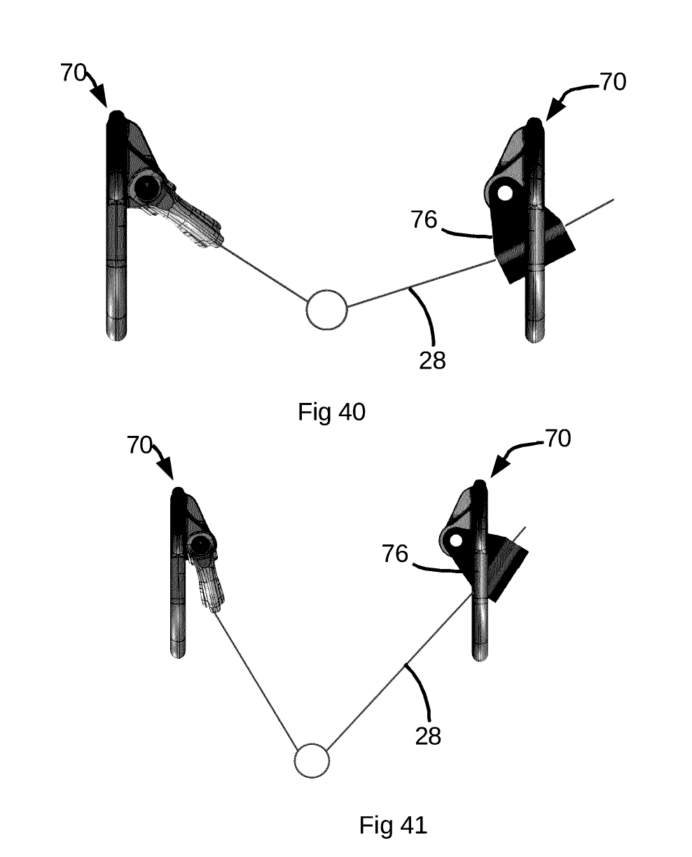

FIG. 37 shows the configuration adopted when a user is connected to the flexible connecting element 28 at a central position. FIG. 38 shows the configuration adopted when a user 82 is in an extreme angled position with a sliding attachment point 82 at the far left. Note how the shackles 74 pivot to the angle of least resistance. Due to the profile of the shackle 74, the flexible textile member 28 can also translate and flex in the vertical aspect as well, as shown in FIG. 39.

The load-bearing flexible member 28 can be extended and retracted easily and quickly with the option of a rope adjusting device 76. The rope adjusting device 76 can be added and removed because the shackle 74 is removably attached to the body 72.

1. A harness comprising a back, a flexible load-bearing member and a side connection arrangement, in which each side connection arrangement includes a base that is fixed to the back and a primary connection element removably connected to the base, in which the flexible load-bearing member is connected to the connection element such that upon removal of the connection element from the base, the load-bearing member can be removed from or connected to the connection element.

2. A harness according to claim 1 in which the primary connection element is in the form of a shackle.

3. A harness according to claim 1 in which the primary connection element includes a tubular spacer.

4. A harness according to claim 1 in which the primary connection element is connected to the base by a removable bolt.

5. A harness according to claim 1 in which the primary connection element is a removable bolt.

6. A harness according to claim 1 in which the primary connection element can pivot about with respect to the base.

7. A harness according to claim 1 in which the side connection arrangement further includes a secondary connection element.

8. A harness comprising according to claim 7 in which the secondary connection element is in the form of a shackle.

9. A harness comprising according to claim 7 in which the primary and secondary connection elements can pivot with respect to the base about a common axis.

10. A harness comprising according to claim 7 in which the primary and secondary connection elements can each pivot with respect to the base about a respective axis.

11. A harness according to claim 1 in which the base is formed from two interconnected components that can pivot with respect to one another.

12. A harness according to claim 1 having leg loops, the flexible load-bearing member being a riser extending from each leg loop to be secured to the primary connection element of a respective side connection arrangement.

13. A harness according to claim 1 having two similar side connection arrangements.

14. A harness according to claim 13 having a waist webbing connected to each of the side connection arrangements.

15. A harness according to claim 1 having a buckle for releasably interconnecting free ends of the waist webbings.

16. A harness according to claim 1 having a waist webbing adjuster operable to adjust the length of the waist webbing when the harness is in use.
